(19) United States
(12) Patent Application Publication
(10) Pub. No.: US 2010/0290354 A1
(43) Pub. Date: Nov. 18, 2010

(54) METHOD FOR DETERMINING ETHERNET MODE OF OPERATION DURING PASSIVE MONITORING

(75) Inventor: David Kucharczyk, Santa Fe, NM (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: VSS MONITORING, INC., Burlingame, CA (US)

(21) Appl. No.: 12/467,053

(22) Filed: May 15, 2009

(51) Int. Cl. H04L 12/26; G06F 11/10

(52) U.S. Cl. 370/252; 714/49; 714/E11.032

(57) ABSTRACT

A procedure for determining the mode of operation of an Ethernet network during passive monitoring of the network. A passive tap is introduced into a network and configured to operate according to a first Ethernet mode. The tap determines whether or not it is operating in the same mode as that being used by devices within the network segment being monitored. If so, the tap continues to operate in the current mode, otherwise, the tap switches modes and the process repeats until the tap is deemed to be operating in the correct mode.

### FIELD OF THE INVENTION

The present invention relates generally to methods of monitoring data transiting switched packet networks and, more particularly, to procedures for determining the mode of operation of an Ethernet network during passive monitoring of the network.

### BACKGROUND

The prevalence of computer networks within businesses and homes has led to a need to monitor traffic being passed over such networks. Such monitoring may be active or passive. Passive or “non-intrusive” monitoring, as the name implies, is performed so as not to interfere with the flow of network traffic. So-called “taps” are placed within networks to listen in on the traffic being passed between devices in those networks. Active or “intrusive” monitoring, on the other hand, results in the division of a network into two, or more, segments, with information being actively transmitted to and from taps positioned at endpoints of those segments. The present invention is concerned primarily with passive monitoring.

Ethernet is perhaps the most prevalent form of computer network technology in use today and is defined by a number of wiring and signaling standards for its physical layer (the so-called PHY). Over the years since its initial development, the family of Ethernet technologies has grown to include both half-duplex and full-duplex versions for a variety of data rates over twisted-pair cables and other media. These include 10Base-T Ethernet, operating at 10 Mbit/s, “Fast” Ethernet, operating at 100 Mbit/s, and “Gigabit” Ethernet, operating at 1000 Mbit/s.

Each of these Ethernet versions employs its own signaling protocol and encoding scheme for conveying data between network devices. For example, 10Base-T Ethernet employs Manchester encoding, in which data values (i.e., a logic 0 or a logic 1) are identified by the direction of the signal transition (high to low or low to high, respectively). When no data is being exchanged between devices, the line is left silent, other than for a single pulse sent every 20 msec to indicate the presence of a connected device.

Fast Ethernet and Gigabit Ethernet, on the other hand, employ different schemes that utilize expanded code spaces. For example, Fast Ethernet schemes employ multiple level transition (MLT) signaling with 4B/5B encoding to expand 4-bit patterns into 5-bit patterns. In addition, the line is never left silent. Instead, special idle packets are exchanged between devices when there is no actual data to exchange. Gigabit Ethernet is similar, but uses an 8B/10B encoding scheme that has an even larger code space.

Not all devices are capable of communicating using all of the above Ethernet variants. For example, older devices are less likely to support the faster bit rate protocols. Accordingly, when two Ethernet devices are first connected, they must decide which of the possible Ethernet variants to use to exchange information. To do so, the devices may use a procedure known as autonegotiation in which they exchange information concerning their own capabilities and then choose the fastest Ethernet mode (bit rate and duplex mode) they share in common for further communications. In cases where one of the devices supports autonegotiation but the other does not (or has such functionality disabled), the device capable of autonegotiation may use parallel detection to determine the capabilities of the other device. If parallel detection fails, a half-duplex, 10 Mbit/s communication link is used by default.

The existence of multiple Ethernet modes and varying capabilities of Ethernet equipment presents problems when using passive taps in Ethernet networks. FIG. 1 illustrates a portion of a conventional Ethernet tap 10, showing in particular an interface where the tap is coupled in-line between two network devices 1 and 2. The interface is made up of a pair of isolation transformers 12a, 12b, which are cross coupled so as to allow electrical signals traveling over communication links 14a and 14b to proceed between network devices 1 and 2 without interruption. Communication links 14a and 14b are one pair of a twisted pair communication link coupling network devices 1 and 2, a similar interface of tap 10 exists for the other pair of the twisted pair, allow for full duplex communication between the network devices.

The isolation transformers 12a and 12b allow for inductive coupling of the electrical signals present on the communication links 14a and 14b to be passed as inputs 18a, 18b to a differential amplifier 20. The output of the differential amplifier 20 is provided as an input to a PHY module 22, which is communicatively coupled to a controller 16 within tap 10. The controller may be a processor or a field programmable gate array (FPGA) programmed to perform specific functions. PHY module 22 is a conventional Ethernet PHY receiver or transceiver, and includes the circuitry necessary to receive and store data streams provided by the differential amplifier 20.

Because 10Base-T Ethernet includes periods of silence on the communication links 14a and 14b, it is possible to develop a DC offset in the isolation transformers 12a, 12b. This can lead to problems with tap 10 determining the correct Ethernet mode being used on these communication links, resulting in missed information. Further, because devices such as PHY 22 were not originally intended to be placed into live communication paths between two other Ethernet devices as part of a passive tap without an opportunity to negotiate communication modes with another Ethernet device, it is sometimes the case that the PHY 22 will fail to determine the correct Ethernet mode being used by network devices 1 and 2. Indeed, it is not uncommon for a PHY 22 to misinterpret a relatively busy 10Base-T communication link as a Fast Ethernet communication link, or a 100Base-T link with its constant data transitions as a 10 megabit link. Of course, this can lead to errors in the data recorded by the tap, if any data is recorded at all.

### SUMMARY OF THE INVENTION

In one embodiment, the present invention provides a procedure for determining the mode of operation of an Ethernet network during passive monitoring of the network. The method involves configuring an interface of an Ethernet tap to operate according to a first Ethernet mode, and then determining whether or not the interface is configured to operate in the same Ethernet mode as that being used by devices within a network segment to which the interface is communicatively coupled. If the tap interface is properly configured, the interface is operated in its currently configured Ethernet mode for purposes of monitoring traffic over the network segment. Otherwise, the interface is reconfigured to operate in a different Ethernet mode and the process of determining whether or not the interface is properly configured is repeated until the interface is deemed to be operating in the same Ethernet mode as the devices on the network segment being monitored.

In some embodiments, the determination of whether or not the interface is configured to operate in the same Ethernet mode as that being used by devices within the network segment to which the interface is communicatively coupled involves determining whether or not communication errors are registered by an Ethernet physical layer (PHY) module associated with the interface. Reconfiguring the interface to operate in the different Ethernet modes thus involves reconfiguring the PHY module accordingly, and then waiting a predetermined period of time before determining whether or not new communication errors are registered by the PHY module. The procedure may be performed for a predetermined number of iterations until other action is taken.

In some instances, after configuring the interface to operate according to the first Ethernet mode, the procedure involves determining whether or not a live communication link is detected before determining whether or not the interface is configured to operate in the same Ethernet mode as that being used by devices within the network segment to which the interface is communicatively coupled. If no live communication link is detected, the PHY may be reconfigured to a different Ethernet mode of operation and the process of determining whether or not a live communication link exists is repeated until such a live link is recognized.

These and other features and embodiments of the invention are described further below.

### BRIEF DESCRIPTION OF THE DRAWINGS

The present invention is illustrated by way of example, and not limitation, in the figures of the accompanying drawings in which:

FIG. 1 illustrates a portion of a conventional Ethernet tap, showing an interface between the tap and one pair of a twisted pair Ethernet communication link between two network devices; and

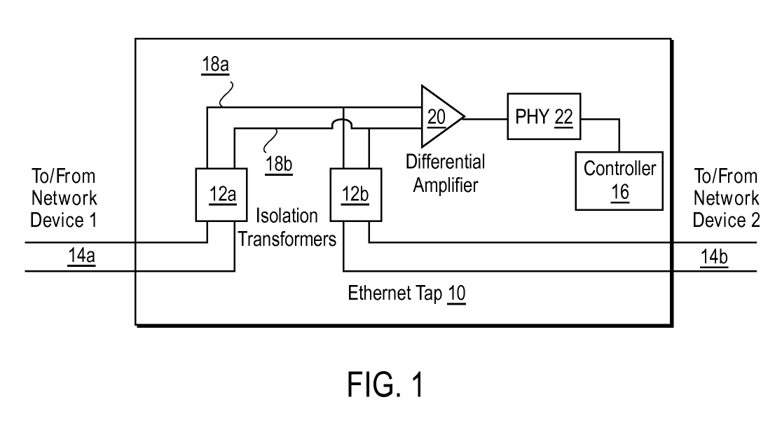

FIG. 2 is a flow diagram showing a process for determining the mode of operation of an Ethernet network during passive monitoring of a network, according to one embodiment of the present invention.

### DETAILED DESCRIPTION

In order to prevent errors of the kind discussed above and, more generally, to ensure that a passive Ethernet tap will always be configured to operate in the correct Ethernet mode, the present invention provides a procedure for determining the mode of operation of an Ethernet network during passive monitoring of the network. In brief, when a passive tap is introduced into a network over which communications are already taking place, or upon power up, the tap is configured to operate according to a first Ethernet mode. After a short time of operating in this fashion, a controller reads error registers within PHY modules associated with one or more of the tap's interfaces and determines whether or not the tap is operating in the same mode as that being used by devices within the network segment being monitored. If so, the tap continues to operate in the current mode, otherwise, the tap switches modes and the process repeats until the tap is deemed to be operating in the correct mode. In this way, the subject tap interface will eventually by configured to operate in the same Ethernet mode as the devices associated with the monitored link.

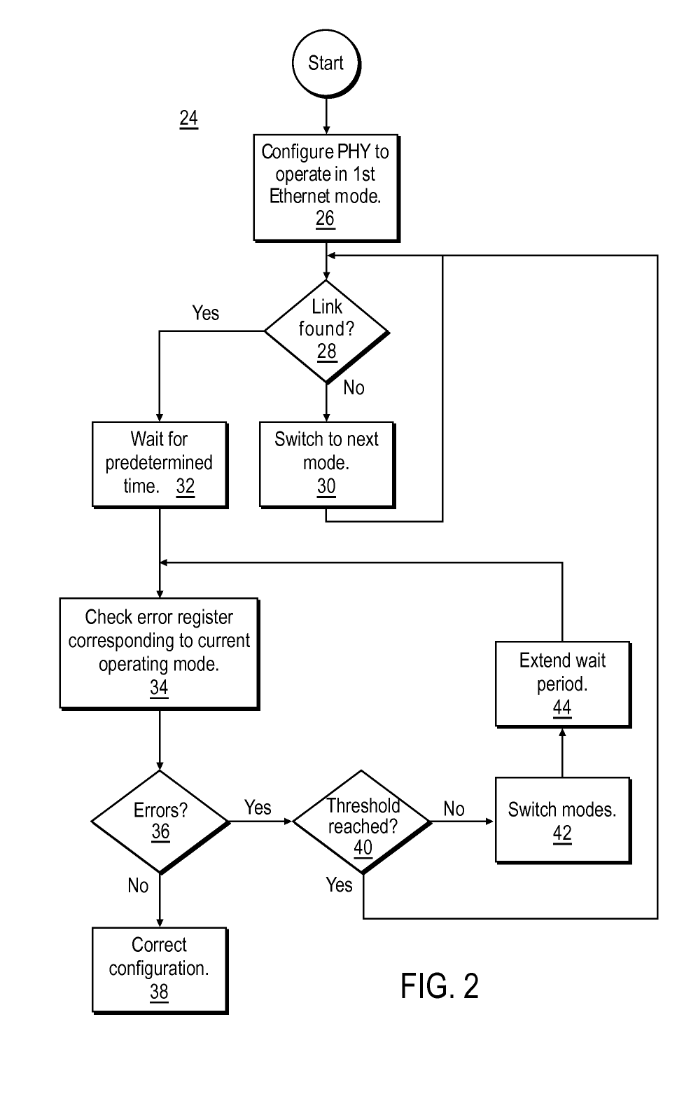

To better understand the above, refer to FIG. 2, which is a flow diagram showing a process 24 for determining the mode of operation of an Ethernet network during passive monitoring of the network according to one embodiment of the present invention. Once the Ethernet tap 10 has been introduced into the network, then on power-up, or at another time (e.g., upon a command to initiate the subject process), the Ethernet tap 10 (i.e., the controller thereof) configures the PHY module 22 to operate in a first Ethernet mode (26). For example, the controller may configure the PHY module to operate in a 10Base-T, full duplex mode. The controller then determines whether a link is seen (28). That is, the controller interrogates the PHY module 22 to determine whether or not the PHY module is detecting the presence of any electrical signals on the communications links 14a, 14b through which the tap interface is connected to the network. This can be done, for example, by having the controller read an appropriate register of the PHY module 22 which records the presence of a live communication link.

If no link is detected, then the controller reconfigures the PHY module to operate according to a different Ethernet mode (30). For example, the controller may reconfigure the PHY to operate according to one of the Fast Ethernet modes or to a half duplex mode, etc. The controller then interrogates the PHY to determine if a link is seen while operating in this new mode, and the procedure continues until a live link is detected which operating in a particular Ethernet mode.

Simply because the PHY has determined that a live communication link exists, however, is no guarantee that the PHY is operating in the same Ethernet mode as that being used by the network devices connected to the communication link being monitored. Accordingly, a further process is used to determine if the PHY is in fact operating in the correct mode. As shown in the illustration, this involves the controller waiting for a first predetermined period of time (32), say a few seconds, e.g., 2 sec, and then reading an error register of the PHY corresponding to the current operating mode.

Recall that the different Ethernet modes all use different signaling/encoding schemes. 10Base-T Ethernet uses non-return to zero (NRZ) Manchester encoding, Fast Ethernet uses MLT 4B/5B encoding and Gigabit Ethernet uses 8B/10B encoding. A PHY configured to operate in one of these modes that is placed in a communication path between devices configured to operate in a different mode will soon log errors as it tries to interpret the data that is being recorded. For example, a PHY that is configured to operate using 10Base-T encoding will quickly register errors if the network devices which it is monitoring are communicating using Fast Ethernet. This is because the Fast Ethernet signaling schemes are such that voltage signals vary between logic +1, logic 0, and logic −1 (i.e., MLT signaling). Because NRZ Manchester encoding has no logic 0 crossings, the presence of logic 0 to logic −1 or logic −1 to logic 0 transitions, for example, are an indication that a different signaling scheme is being used over the communication links 14a, 14b. This will case the PHY module 22 to register Manchester code violation errors.

Likewise, a PHY configured to operate using Fast Ethernet will quickly register errors if in fact the communications between the network devices are using 10Base-T Ethernet. The 4B/5B encoding used by Fast Ethernet includes several prohibited code combinations. Such prohibited codes would be observed rather readily, however, if in fact the monitored communication link was transporting Manchester-encoded information.

Therefore, when the controller reads the error registers in the PHY, it determines whether any errors associated with the currently configured operating modes were observed (36). If not, the controller can be satisfied that the PHY is operating is the same mode as the devices which are communicating over the monitored communication links 14a, 14b, and the configuration process is complete.

Otherwise, if errors are observed for the current operating mode (36), the controller may check to see whether a predetermined number of configuration attempts have been made (40), and if not, may reconfigure the PHY to operate in a different Ethernet mode (42). Once the PHY has been set to the new operating mode, the procedure of checking the error registers may be repeated. Optionally, with each successive change in operating mode, the controller may wait extended periods of time before checking the error registers for indications of communication errors (44). For example, with each iteration of the process, the wait time may be extended exponentially from the previous wait time. Alternatively, the controller may use the same wait time during each iteration.

After a designated number of iterations of checking and finding communication errors registered by the PHY (say four or five such iterations), the controller may revert to the earlier part of the configuration process and begin checking once more for the presence of a live communication link. Alternatively, the control may simply revert to using the initial waiting time (32) before checking the PHY's error registers. Eventually, the controller will configure the PHY to the correct operating mode and the tap interface will be properly configured.

As an alternative to the above schemes, or in addition thereto, embodiments of the present invention may involve examining network traffic for cyclic redundancy check (CRC) errors. Many, if not most, PHYs for network taps are configured for CRC error detection. Accordingly, controller 16 may be configured to examine decoded network traffic received by PHY 22 to determine whether or not an unusually high number of CRC errors are being detected. This may be determined with reference to a threshold that specifies a predetermined number of CRC errors within a given time period, or simply an absolute number of CRC errors. If PHY 22 is not configured to determine CRC errors, then controller 16 (or another functional unit of the tap 10) may be so configured. Thus, instead of or in addition to recognizing Manchester code violation errors or 4B/5B prohibited codes, or other layer 1 errors, if an unusually high number of CRC errors are found when the tap is operating in one mode but not in another mode, this may be taken as an indication that the mode in which the errors appear is not the correct mode of operation (i.e., it is a different Ethernet mode than is being used by the other network equipment).

As indicated in conjunction with the discussion of the procedure illustrated in FIG. 2, the operations performed by the tap controller and the PHY are those requiring physical manipulations of physical quantities; in particular, the electrical or magnetic signals on communication links 14a, 14b. The representations of those signals are stored, transferred, combined, compared and otherwise manipulated as described herein. It has proven convenient at times, principally for reasons of common usage, to refer to these signals as bits, values, symbols, codes, and the like, but it should be remembered that all of these and similar terms are to be associated with the appropriate physical quantities and are merely convenient labels applied to these quantities. Moreover, terms such as “processing”, “computing”, “calculating”, “determining”, or the like, refer to the action and processes of a controller, or similar electronic computing device, that manipulates and transforms data represented as physical (electronic) quantities within registers and memories into other data similarly represented as physical quantities within memories or registers or other such information storage or transmission devices.

The present invention can be implemented with an apparatus to perform the operations described herein. This apparatus may be specially constructed for the required purposes, or it may comprise an appropriately reconfigured (by way of computer program) device. Such a program may be stored in a computer-readable storage medium, such as, but not limited to, a hard disk, read-only memory (ROM), random access memory (RAM), electrically programmable ROM (EPROM), electrically erasable programmable ROM (EEPROM), or any type of media suitable for storing such instructions.

The algorithms and processes presented herein are not inherently related to any particular apparatus. For example, a programmable device may be utilized (along with an appropriate program instruction set), or it may prove convenient to construct more specialized apparatus to perform the required method. For example, any of the methods according to the present invention can be implemented in hard-wired circuitry, or by programming and FPGA or similar device.

Although discussed with reference to various examples, these examples should not be read as limiting the present invention. Instead, the invention should be measured only in terms of the claims, which follow.

What is claimed is:

1. A method for determining the mode of operation of an Ethernet network during passive monitoring of the network, the method comprising configuring an interface of an Ethernet tap to operate according to a first Ethernet mode, determining, by the Ethernet tap, whether or not the interface is configured to operate in a same Ethernet mode as that being used by devices within a network segment to which the interface is communicatively coupled, and if so, operating the interface in a currently configured Ethernet mode, otherwise, reconfiguring the interface to operate in a different Ethernet mode and repeatedly determining whether or not the interface is configured to operate in the same Ethernet mode as that being used by devices within the network segment to which the interface is communicatively coupled until the interface is deemed to be operating in the same Ethernet mode as said devices.

2. The method of claim 1, wherein determining whether or not the interface is configured to operate in the same Ethernet mode as that being used by devices within the network segment to which the interface is communicatively coupled comprises determining whether or not communication errors are registered by an Ethernet physical layer (PHY) module associated with the interface.

3. The method of claim 2, wherein reconfiguring the interface to operate in the different Ethernet mode comprises reconfiguring the PHY module to operate in the different Ethernet mode and waiting a predetermined period of time before determining whether or not new communication errors are registered by the PHY module.

4. The method of claim 1, wherein repeatedly determining whether or not the interface is configured to operate in the same Ethernet mode as that being used by devices within the network segment to which the interface is communicatively coupled is performed for a predetermined number of iterations.

5. The method of claim 1, wherein after configuring the interface to operate according to the first Ethernet mode, determining whether or not a live communication link is detected before determining whether or not the interface is configured to operate in the same Ethernet mode as that being used by devices within the network segment to which the interface is communicatively coupled.

6. The method of claim 5, wherein if no live communication link is detected, switching Ethernet modes of operation and again determining whether or not a live communication link is detected before determining whether or not the interface is configured to operate in the same Ethernet mode as that being used by devices within the network segment to which the interface is communicatively coupled.

7. The method of claim 2, wherein the communication errors comprise cyclic redundancy check (CRC) errors in network traffic.

8. The method of claim 2, wherein the communication errors comprise coding errors in network traffic.
